(19) United States
(12) Patent Application Publication
(10) Pub. No.: US 2014/0372440 A1
(43) Pub. Date: Dec. 18, 2014

(54) MMA Glove Incorporating a Tightly Secured Wireless Impact Processing Circuit

(71) Applicant: Steven Cains, London (GB)

(72) Inventor: Steven Cains, London (GB)

(73) Assignee: BOXNG TECH LIMITED, London (GB)

(21) Appl. No.: 13/920,260

(22) Filed: Jun. 18, 2013

(51) Int. Cl. A63B 69/32; G06F 17/30; A63B 71/14

(52) U.S. Cl. CPC A63B 69/32; A63B 71/145; G06F 17/30705; A63B 2220/53; A63B 2220/80
USPC 707/737; 2/161.1

(57) ABSTRACT

An improved mixed martial art (“MMA”) glove includes an impact sensing circuit board that holds a microcontroller, a three-axis accelerometer, a wireless interface chip, and is coupled to an impact sensing circuit. The circuit board is securely mounted to the wrist portion of the improved MMA glove by one or more sewing holes.

### FIELD OF THE DISCLOSURE

The present invention generally relates to sporting goods, and more particularly relates to a glove worn by a participant in a pugilistic match, and more particularly still relates to a mixed-martial art glove, and even more particularly still relates to a mixed-martial art glove incorporating impact detecting circuitry for detecting impact of the striking surface of the glove, and further incorporating tightly secured wireless impact processing circuitry for transmitting a force detecting by the force detecting sensor to a remote computer, such as a wireless tablet computer or a server.

### DESCRIPTION OF BACKGROUND

Pugilistic match sports, such as boxing, have been enjoyed for many years by millions (or perhaps billions) of sports fans. In boxing, heavy padded gloves covering the entire hand are worn by the participants to lessen the probability of serious injury from being inflicted on a participant. On the other hand, participants in MMA matches wear lighter, less padded gloves, which leave part of the fingers uncovered. Nonetheless, the technology used within fighting gloves (boxing or MMA) has remained more or less constant for many years.

Recently, however, the integration of impact sensors into fighting gloves have provided opportunities for improvements in both training for matches, and for the scoring of actual matches. In particular, the integration of a force sensor with a wireless transceiver into a fighting glove allows for the transmission of strike information in real time as it occurs.

U.S. Pat. No. 6,925,851 (“the '851 patent”) discloses a prior art attempt to create a boxing glove incorporating a force sensor and a wireless transceiver. However, there are a number of improvements that can be made to the boxing glove disclosed by the '851 patent. First, the '851 patent deals with boxing, rather than MMA gloves. First, as boxing gloves are larger than MMA gloves, minimal effort was made to size the circuitry for use in smaller MMA gloves. Second, the signal acquisition circuitry utilized by the '851 patent does not condition the force signal to remove noise, and accordingly, will provide an erroneous indication of the force of a particular impact. Third, the '851 patent does not disclose any way of securely mounting an impact processing board within the glove. Accordingly, the system of the '851 patent cannot be used in real conditions requiring reliability, as the impact processing circuitry will quickly break. Fourth, the '851 patent discloses the wireless transmission of impact forces to stationary computers, rather than wireless tablets, smartphones, and other mobile devices that are likely to be more accessible to trainers, reporters, and other viewers of the fight. Fifth, the '851 patent discloses the selective transmission of information rather than the transmission of the raw impact data, which prevents the more powerful processor available outside of the gloves from performing analysis on the raw impact data. And sixth, the '851 patent does not disclose any way of classifying a particular punch into, for example, a jab, hook, cross, or uppercut. Therefore, there is a need for an improved MMA glove incorporating an improved wireless impact processing circuit.

### OBJECTS OF THE DISCLOSED SYSTEM, METHOD, AND APPARATUS

Accordingly, it is an object of this disclosure to provide an improved MMA glove.

Another object of this disclosure is to provide an improved MMA glove incorporating a wireless impact processing circuit.

Another object of this disclosure is to provide an improved MMA glove incorporating a securely mounted wireless impact processing circuit.

Another object of this disclosure is to provide an improved MMA glove incorporating a wireless impact processing circuit adapted to interface with a wireless tablet computer,

Another object of this disclosure is to provide an improved MMA glove incorporating a wireless impact processing circuit that provides for an accurate measurement of impact force.

Another object of this disclosure is to provide an improved MMA glove incorporating a wireless impact processing circuit that transmits raw impact data.

Another object of this disclosure is to provide a wireless computer incorporating software that can classify a punch into a particular type of punch, such as a jab, hook, or cross,

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

An improved mixed martial art (“MMA”) glove includes an impact sensing device disposed beneath the striking surface, of the glove. The impact sensing circuitry is coupled to an impact processing circuit disposed within the wrist portion of the improved MMA glove. The impact processing circuitry incorporates a three-axis accelerometer, a microcontroller or microprocessor and a wireless interface chip. The microcontroller gathers digital representations of data from the impact sensing circuitry and the three-axis accelerometer, and transmits them to a coupled wireless computer. The impact processing circuitry is securely mounted to the wrist portion of the improved MMA glove by one or sewing holes disposed in a PC board comprising the impact processing circuit.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a system diagram depicting a fighter training with a set of improved MMA gloves constructed in accordance with this disclosure;

FIG. 2 is a system diagram of fighters wearing sets of improved MMA gloves constructed in accordance with this disclosure sparring;

FIG. 3 is an image from software adapted to retrieve and display information gathered from the improved MMA gloves constructed in accordance with this disclosure;

FIG. 4a is a top view of an improved MMA glove constructed in accordance with this disclosure;

FIG. 4b is a top view of an improved MMA glove constructed in accordance with this disclosure with portions exploded to show the placement of impact sensing and processing circuitry;

FIG. 4c is a front view of an improved MMA glove constructed in accordance with this disclosure with portions exploded to show the placement of impact sensing circuitry;

FIG. 4d is a side view of an improved MMA glove constructed in accordance with disclosure with portions exploded to show the placement of impact sensing and processing circuitry;

FIG. 5 is a simplified schematic diagram of the impact processing circuitry used within the disclosed improved MMA glove;

FIG. 6 is a schematic diagram of the impact processing circuitry used within the disclosed improved MMA glove;

FIG. 7 is a circuit board used with the impact processing circuitry used within the disclosed improved MMA glove;

FIG. 8 is a flowchart depicting the software operating on a wireless computer adapted to retrieve and display information gathered from the improved MMA gloves constructed in accordance with this disclosure;

FIG. 9 is a flowchart depicting the process by which software operating on the wireless computer gathers and assembles force samples;

FIG. 10 is a flowchart depicting the process by which software operating on the wireless computer determines which force samples correspond to punches;

FIG. 11 is a flowchart depicting the process by which software operating on the wireless computer gathers and assembles three-axis acceleration samples; and

FIG. 12 is a flowchart depicting the process by which software operating on the wireless computer classifies punches;

FIG. 13 is a flowchart depicting a pattern matching process by which software operating on the wireless computer classifies punches using three-axis accelerometer data;

FIG. 14 is a flowchart depicting a machine learning algorithm by which a large database of classified punch data can be generated; and

FIG. 15 is a flowchart depicting a punch classification algorithm utilizing a database of previously classified punches.

### DETAILED DESCRIPTION

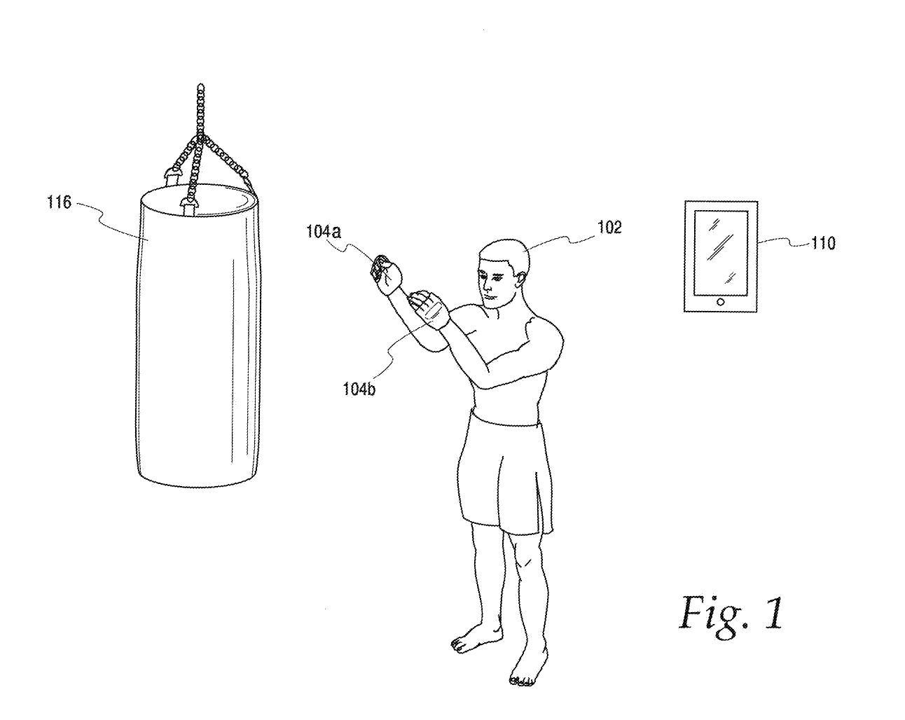

Turning to the Figures and to FIG. 1 in particular, a fighter 102 wearing a set of improved MMA gloves 104a,104b constructed in accordance with this disclosure is depicted. The improved MMA gloves 104a,104b wirelessly communicates force impacts to a wireless tablet computer 110. While a wireless tablet computer is depicted, other types of computers, such as a smart phone, laptop computer, desktop computer, or other type of computer could be used instead. In addition, a wireless relay device, such as a wireless access point, could relay information to a remote computer. As depicted herein, the fighter is training with a heavy bag 116, which can be a traditional heavy bag such as those manufactured by Everlast WorldWide, Inc.

The use of a bag allows a fighter to perfect his punching technique. However, minimal objective data is available to a fighter training with a heavy bag. Instead, to obtain objective feedback, a fighter must either (1) video tape his or her training or (2) be monitored by a “coach.” Video of a training session can provide a subjective overview of the fighters punching speed, punching power, and in some cases, foot work. However, video does not provide “raw data” regarding a fighter's punching speed and power. Similarly, a coach can provide the subjective view of an experienced observer of a fighter's punching skills. The use of the improved MMA gloves 104a,104b disclosed herein provides the missing “raw data:” i.e., the actual punching speed and power of a fighter, which eliminates at least some of the subjectivity when judging a fighter's training direction.

The improved MMA gloves 104a,104b utilize a “thin” protocol with minimal digital processing performed on the MMA gloves (as discussed below, some analog processing is done to ensure higher quality signal acquisition). Accordingly, the actual force readings from the gloves impact sensor (discussed further herein) are sent multiple times every second from the MMA gloves 104a,104b to a computer system, such as the wireless tablet 110 depicted in FIG. 1. In one embodiment of the disclosed MMA gloves 104a,104b the output of the force sensor is wirelessly transmitted once every millisecond, or 1000 times per second.

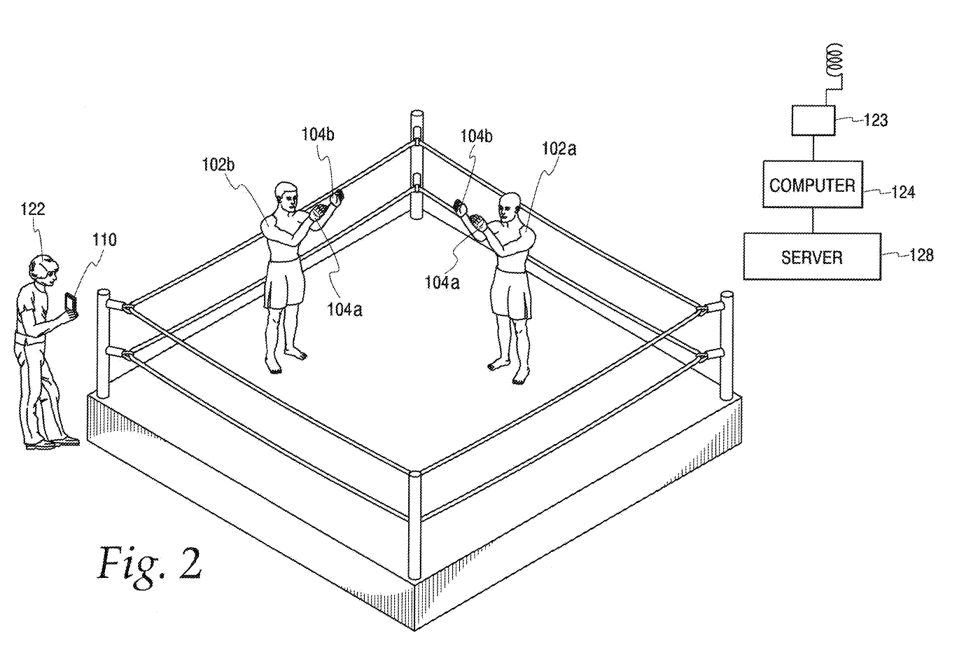

FIG. 2 depicts a pair of fighters 102a,102b engaged in a match. Both fighters 102a,102b wear identical MMA gloves 104a,104b constructed in accordance with this disclosure. An individual 122 in the audience monitors the fight on a wireless tablet computer 110. The individual 122 could, for example, be a reporter or a judge. Alternatively, the individual 122 could be a fan in the audience. In addition, a computer 124 is coupled to a wireless network interface 123. The computer 124 relays information to a server 128, which prepares punch information as discussed herein for display to an audience, which could be, for example, the audience present at the fight venue or a television audience.

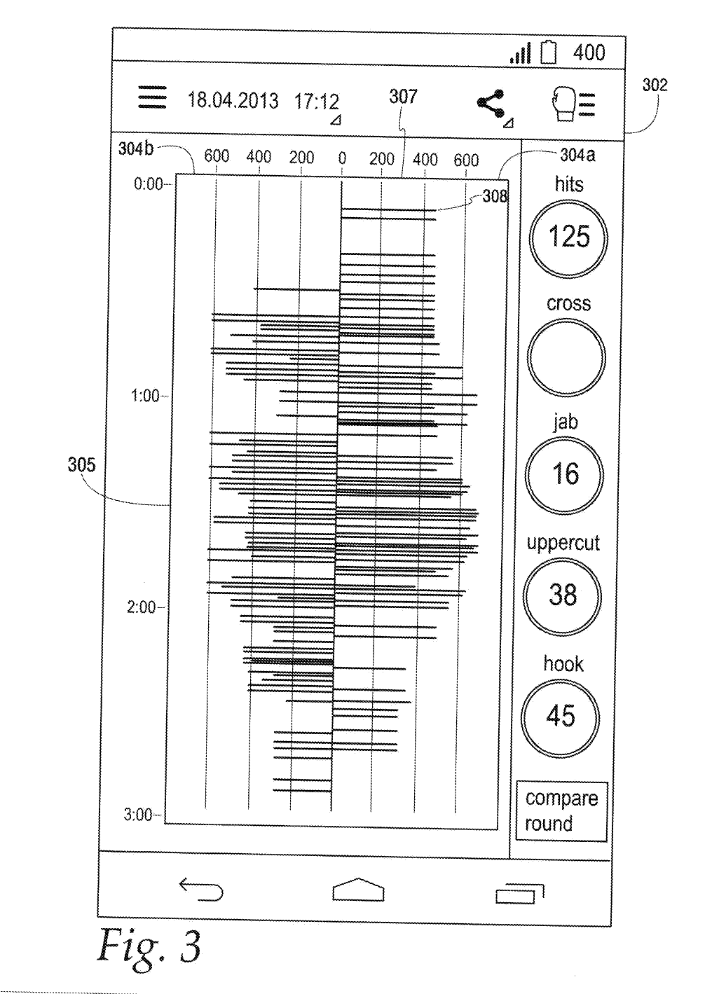

The information transmitted by the improved MMA gloves 104a,104b can be used to provide information useful to persons watching, judging or reporting on the fight. For example, as explained herein, software operating on a computer wirelessly coupled to the MMA gloves 104a,104b can determine the number of punches that were thrown, the types of punches that were thrown, and the force behind each punch as depicted in FIG. 3. This information can be especially useful to judges, who can then make a more objective determination as to which fighter won or lost a round.

As shown in FIG. 3, the impact data processing software produces a round summary 302. The round summary 302 comprises individual summaries 304a, 304b for each glove 104a,104b. The vertical axis 305 depicts the elapsed time for each round from zero to three minutes. For each particular time interval, the impact force that was transmitted by the MMA gloves 104a,104b is displayed on the horizontal axis 307 by a horizontal bar, such as bar 308, where a longer bar signifies greater impact force. As explained further herein, a three-dimensional accelerometer provides three-dimensional acceleration data for each punch, which allows software operating on an interfacing computer to determine a punch type for each punch. As depicted on the readout the impact processing software can differentiate between a cross, a jab, an uppercut, and a hook.

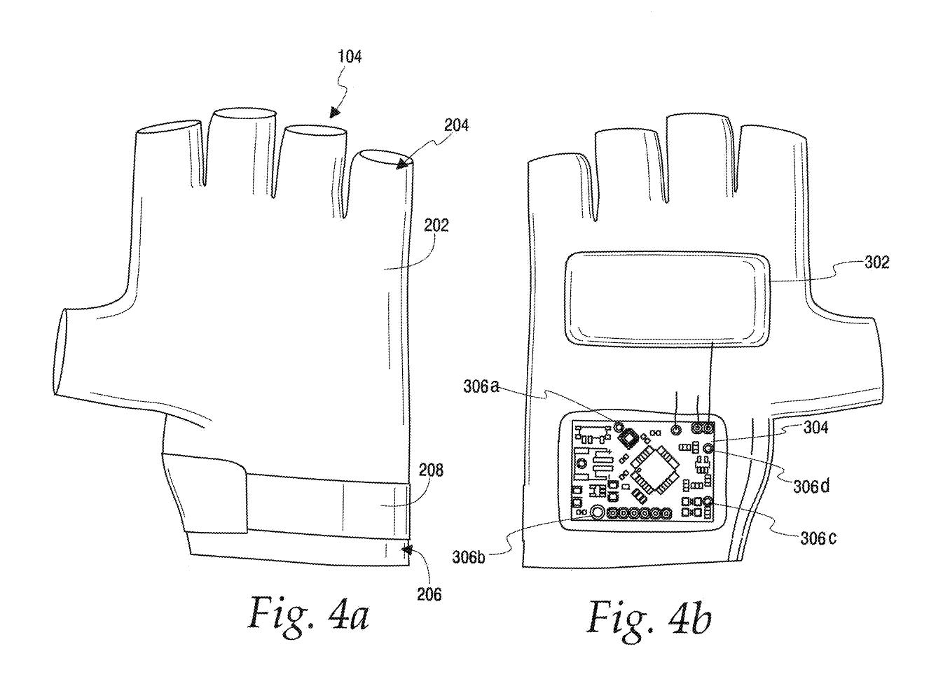

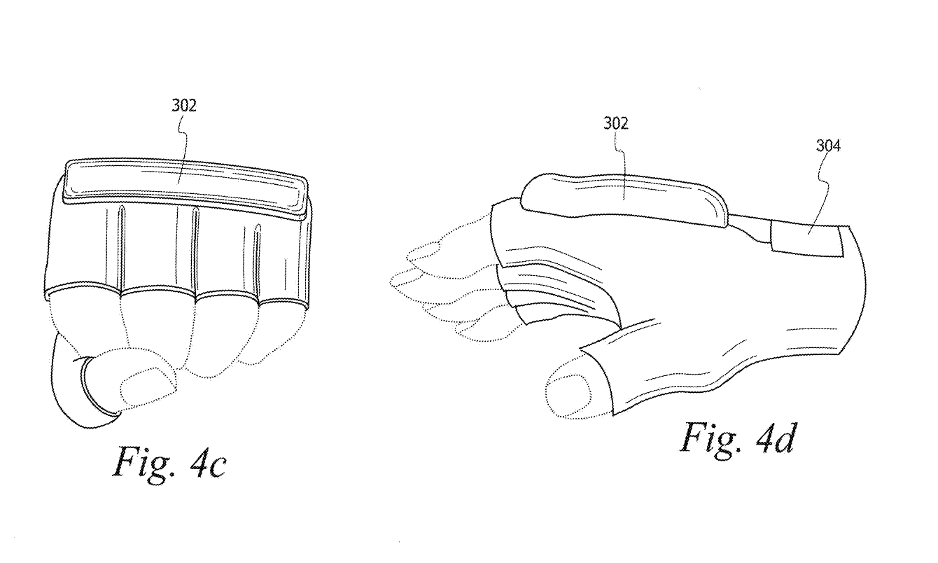

Turning to FIG. 4a, a top view of the disclosed improved MMA glove 104 is depicted. The outer surface 202 of the improved MMA glove 104 can be constructed of leather, or some other durable, flexible material. The interior will generally comprise a foam padding and a nylon or polyester lining. It should be noted that other materials could also be used; for example, gel could be used in place of foam. The MMA glove 104 comprises a finger region 204 that is adapted to fully cover the knuckles of each finger, while allowing each finger independent articulation so as to enable, for example, grappling maneuvers. The MMA glove 104 further comprises a wrist region 206 and a strap 208, which may have, for example, a Velcro clasp. FIG. 4b shows an exploded view of the same MMA glove 104 with the impact sensing circuitry 302 and impact processing circuitry 304 shown as mounted in the glove. The impact sensing circuitry 302 can be comprised of, for example, a fabric pressure sensor. Alternatively, the impact sensing circuitry can be comprised of, for example, a capacitive force sensor having two or three plates and an open-cell polyurethane foam dielectric and flexible conductive mesh conductors. Other types of capacitive force sensors could work equally as well, and this disclosure is not intended to be limited to the specific type of force sensor disclosed. In addition, a circuit could be constructed using other force sensing components, such as, for example, a force sensitive resistor.

As depicted, the impact processing circuitry 304 is securely mounted to the glove through multiple sewing holes 306a,306b,306c,306d,306e. As the impact processing circuitry can be damaged if it becomes unseated, a heavy duty thread, such as, for example, a silverized nylon conductive thread, although other heavy duty thread will work equally as well. In particular, to aid in holding the impact processing circuitry 304 in place, a number of long diagonal stitches can be used. In contrast, the force sensor, if it is a fabric pressure sensor, can be sewn together using a straight stitch.

FIGS. 4c and 4d depict, respectfully, front and side views of the disclosed improved MMA glove 104, as well as an exploded side view depicting the placement of the impact sensing circuitry 302 and impact processing circuitry 304.

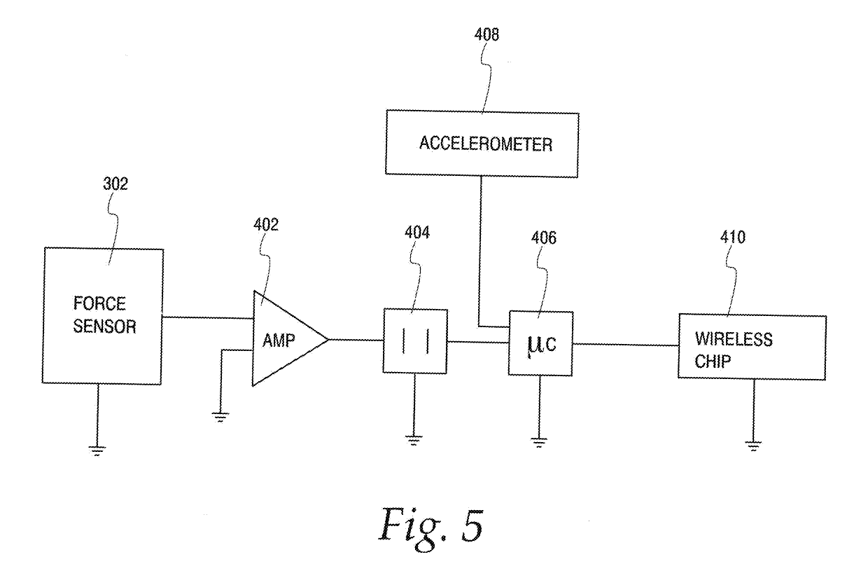

FIG. 5 depicts a simplified schematic diagram of the impact sensing and processing circuitry. A force sensor 302 produces a voltage that varies based on the impact that is sensed. As with other analog signals, a certain baseline nose will be present. However, an actual impact will result in a detectable increase. For example, when a punch is delivered, the voltage of the force sensor will spike.

An amplifier 402 is used to amplify and condition the acquired force sensor signal. In one embodiment, the amplifier may be a low power rail-to-rail amplifier. After amplification, the signal is passed through a filter 404, which is adapted to filter the underlying noise from the relevant impact signal. In one embodiment, the filter 404 can be a low pass filter with a cut-off frequency of approximately 4 kHz, in addition, the filter 404 can be implemented separate from or integrated with the amplifier 402.

The amplified and filtered force signal is then delivered to an analog-digital converter (“ADC”) channel of a microcontroller 406. The ADC channel of the microcontroller 406 performs a digital to analog conversion to generate a digital representation of the force signal. It should be obvious to a person of skill in the art that an independent analog-to-digital converter (ADC) could be used, and the digital representation of the force signal delivered via parallel or serial data lines to a microprocessor or microcontroller.

A three-axis accelerometer 408 provides acceleration information for all three axes—X, Y, and Z. In one embodiment, the accelerometer 408 provides a digitized output via a serial or parallel interface. However, in a separate embodiment, the accelerometer 408 provides multiple analog signals—one corresponding to each axis (X, Y, and Z), each of which is fed into an acquisition channel of the microcontroller 406.

The microcontroller 406 acts as an information conduit for digital representations of the force signal and acceleration signals. In particular, the force signal and the acceleration signals are relayed to a wireless interface chip 410, which transmits them to a paired wireless receiver (not shown). The wireless chip can be, for example, a BlueTooth interface chip, a Zigbee interface chip, an 802.11N interface chip, or any other type of wireless interface chip that is suitable for low latency, low power, short range communications.

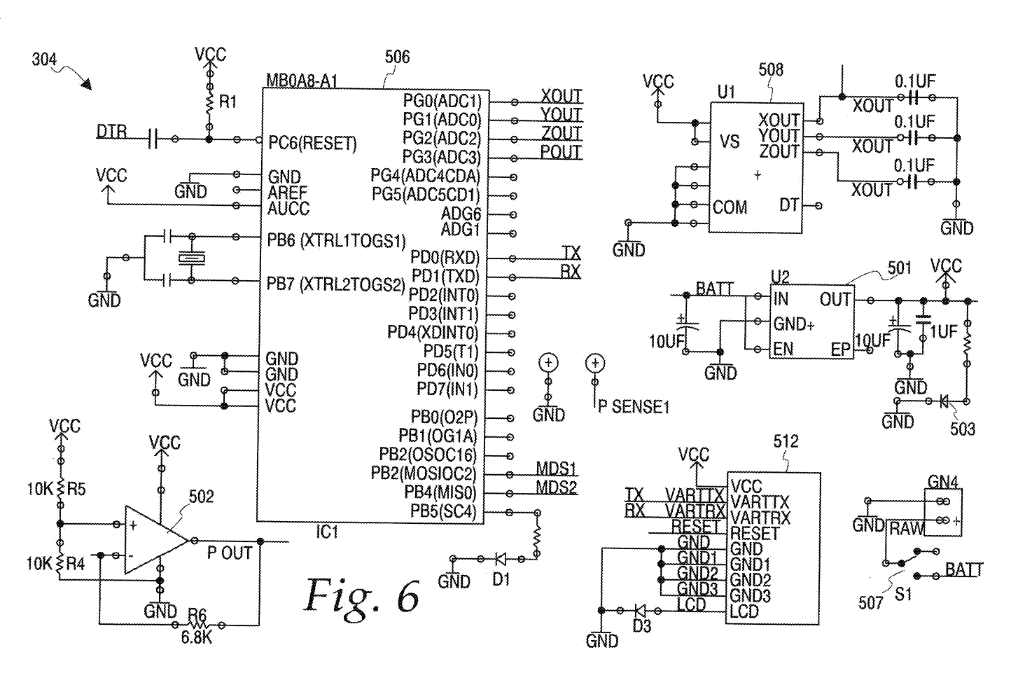

FIG. 6 is a detailed schematic diagram of the impact processing circuitry 304. As depicted a switch 507 can be turned to the on position to couple a battery (not shown) to a voltage regulator 501, which, in this embodiment of the disclosure is an LDO linear regulator, such as a TPS79333DBVRG4, which is readily available from Texas Instruments. The output of the regulator is filtered using the depicted circuitry to produce a regulated supply voltage (labeled V_{cc}). When regulated power is present, an LED 503 will light; when power is removed, the LED 503 will darken.

The force sensor (not shown) is coupled to the negative input of amplifier 502, while the positive input is biased as shown by the support circuitry in the diagram. The negative input of the amplifier 502 is also biased with feedback from the output, as is standard for such circuits. The output of the amplifier is routed to one of the ADC channels of the microcontroller 506.

Similarly, a three-axis accelerometer 508 provides three separate analog signals that are each routed to separate ADC channels of the microcontroller 506. As depicted, the three-axis accelerometer 508 is an Analog Devices ADXL335. Other, similar three-axis accelerometers would work equally well.

As depicted, the microcontroller 506 is an ATmega8 RISC based microcontroller. However, other similar microcontrollers would be equally acceptable. Further, the impact processing circuitry 302 also includes a programming f debug port 512, which allows a programmer to alter the EEPROM holding the firmware executing on the microcontroller 506, as well as to monitor and debug the execution of the firmware.

The impact processing circuitry 302 also includes a wireless module, such as, for example, a BlueTooth module having an integrated antenna (not shown). The BlueTooth module is coupled to the microcontroller 506 by, for example, a serial bus, although a parallel bus would work equally well. The microcontroller 506 forwards force sensor and acceleration data once every millisecond; i.e., at 1 kHz; to the wireless module for transmission to a coupled wireless computer.

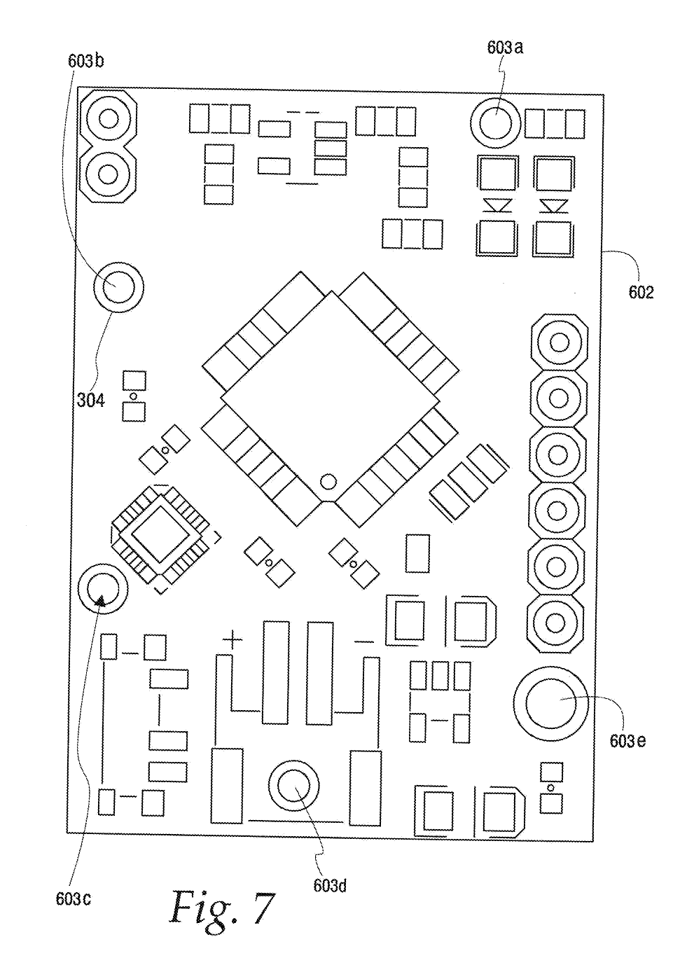

Turning to FIG. 7, one side of the impact processing circuit board 602 is depicted. As depicted, the impact processing circuit board 602 incorporates a number of sewing holes 603a,603b,603c,603d,603e, each of which is disposed on the periphery of the board to allow for easy stitching. Placement of multiple holes distributed about the periphery also ensures that the board will be firmly mounted once it is attached in place.

As discussed earlier with regards to FIG. 3, software running on a wireless computer can produce reports regarding a fighter's performance. For example, software resident on a wireless tablet, such as that used by the observer in FIG. 2, can receive the data wirelessly from the improved MMA gloves 102. As discussed earlier, the software processes both impact data and acceleration data transmitted from the improved MMA gloves 102.

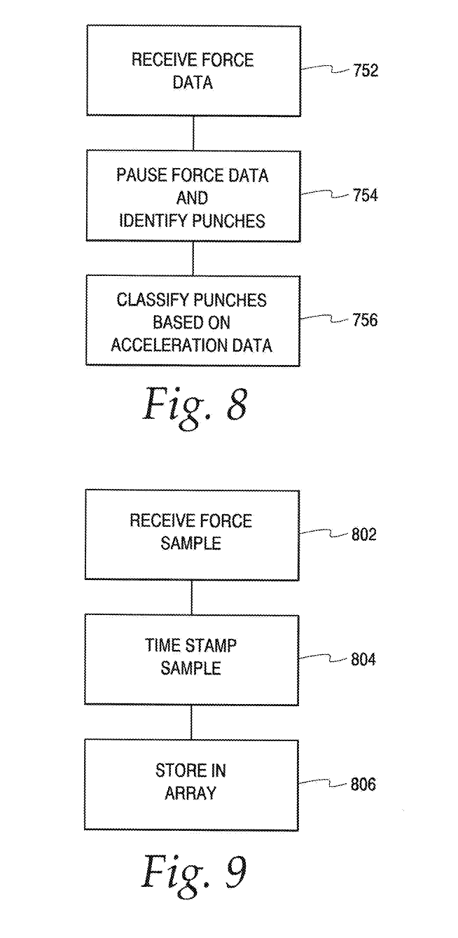

The operation of the wireless computer software is described by the flowcharts in FIGS. 8-12. FIG. 8 is a flowchart describing the basic operation of the wireless computer software from a high level. In step 752 the force data from the improved MMA gloves 102 is received for one session. One session can be one round, one training session, or some other significant period of time. In step 754 the force data is parsed and the punches are retrieved and plotted with the maximum recorded force value. In step 756, the punches that were determined and plotted in step 754 are classified.

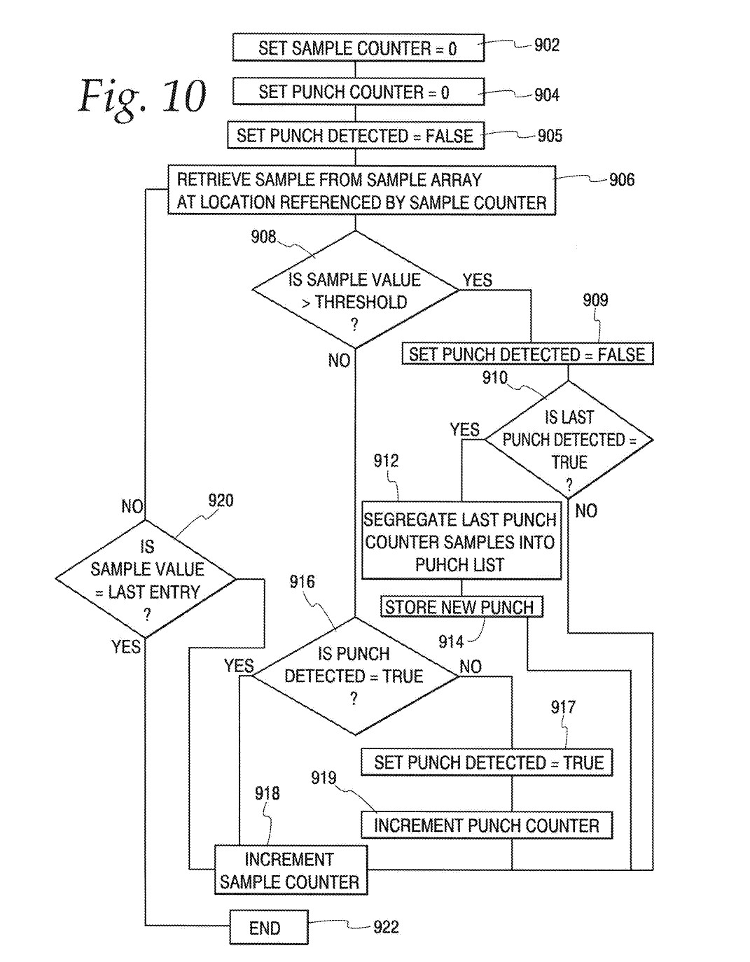

Turning to FIG. 9, a flow chart illustrates the steps used to acquire force samples for a time period. In step 802, a force sample is received from the improved MMA gloves 102. In step 804, the force sample is time stamped, and in step 806, the force sample is stored in an array. Once all force samples for a time period are stored, the punch determination algorithm of FIG. 10 is executed.

FIG. 10 is a flowchart describing the algorithm used by the improved MMA gloves 102. In step 902, a sample counter is initialized to zero. In step 904 a punch counter is similarly initialized to zero. In step 905 a Boolean variable Punch Detected is set to False. In step 906, the sample referenced by the sample counter is retrieved from the sample array. The value of that sample is then compared to a threshold in step 908. If the sample value is less than the threshold, execution transitions to step 909. In step 909 the Boolean variable “Punch Detected” is set to False. In step 910 the Boolean variable Punch Detected is checked to see if it has transitioned from true to false in step 909. If the value of Punch Detected was True prior to execution of step 909, execution continues in step 912. In step 912, the samples corresponding to the noted punch are segregated and stored in a punch array in step 914, and the sample indices are also noted for the recorded punch. Execution then transitions to step 918 where the sample counter is incremented. Returning to step 910 execution also transitions to step 918 if the punch counter is not greater than zero.

Returning to step 908, if the sample value is greater than the threshold value, execution transitions to step 916. In step 916, the Boolean variable Punch Detected is checked to see if it has been set to true. If it has already been set to true, execution transitions to step 918. Otherwise, execution transitions to step 917, where the Boolean variable “Punch Detected” is set to true. In addition, the punch counter is incremented in step 919.

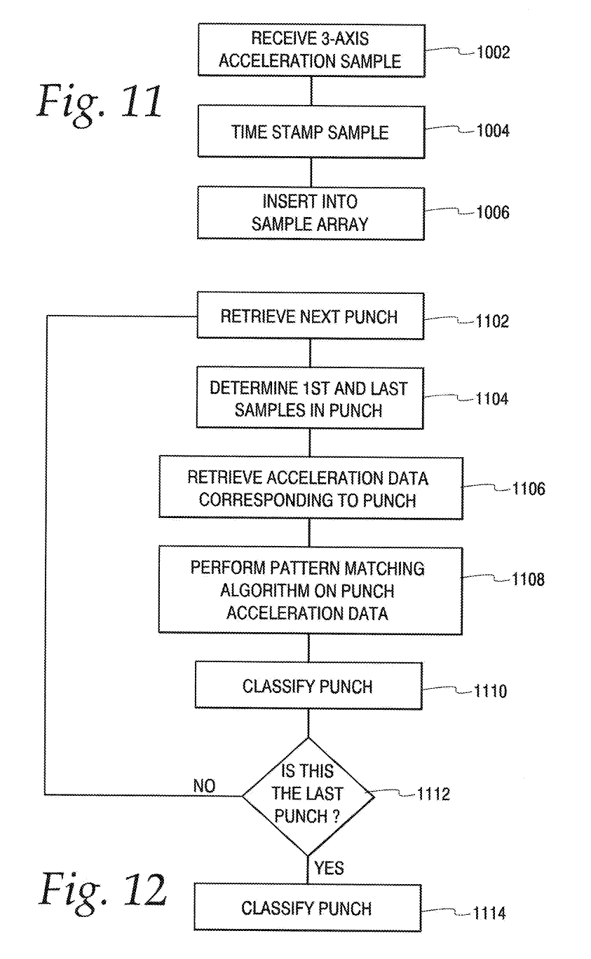

FIG. 11 is a flowchart that describes the process by which three-axis acceleration samples are gathered. In step 1002, a set of three-axis acceleration samples are received. In step 1004, the set of samples are time stamped. Finally, in step 1006, the sample set is inserted into an array.

FIG. 12 is a flowchart that describes the process by which punches are classified. In step 1102 the next punch (starting with the first stored punch) is retrieved. In step 1104 the first and last samples of the punch are determined, and in step 1106, the set of accelerations samples corresponding to the punch samples are retrieved. In step 1108 a three-dimensional pattern matching algorithm is performed on the acceleration data comprising the punch. In step 1110 the punch is classified, and in step 1112, a check is made to determine if the last punch was processed. If not, execution returns to step 1102. Otherwise, the process exits in step 1114.

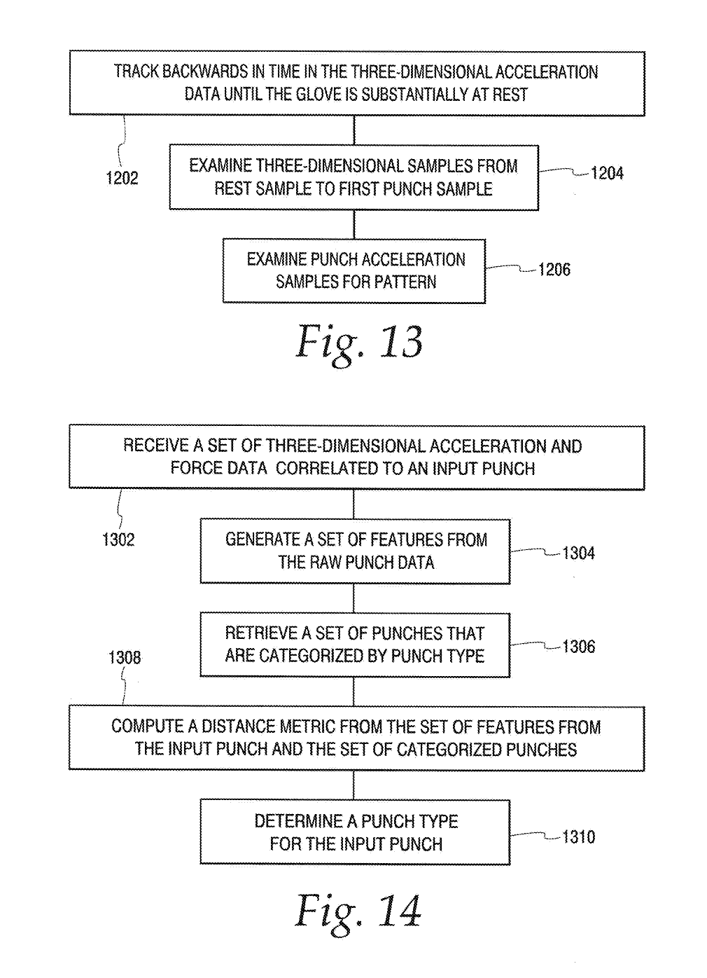

A number of different algorithms can be used to classify punches using information gathered from the improved MMA gloves disclosed herein. Turning to FIG. 13, the algorithms disclosed herein begin by tracking backward in time in the three-dimensional acceleration data from the first sample of the punch to be classified until movement of the fighter's glove begins as illustrated in 1202. In particular, the three-dimensional acceleration data is reported in the X (directly ahead of the fighter), Y (to the right and left of the fighter), and Z (vertically along the body of the fighter) dimensions. As acceleration data is reported every millisecond, a punch will generally begin with acceleration data in all three dimensions being near zero; i.e., the glove begins at rest or nearly so. The pattern of the movement from rest until impact is then examined in step 1204 to identify the three-dimensional acceleration samples corresponding to the punch. In step 1206 the three-dimensional samples corresponding to the punch are examined and classified.

With regards to step 1206, the first algorithm disclosed herein examines the pattern of the three-dimensional acceleration data. If acceleration primarily occurred in the Z dimension, the punch is classified as an uppercut. If acceleration occurred primarily in the X dimension, the punch is classified as a jab. Hooks and crosses are comprised primarily of X and Y acceleration. Generally, a cross will begin with positive X acceleration and Y acceleration in the direction that takes it across the fighter's body. On the other hand a hook will begin with positive X acceleration and Y acceleration that takes it outside of the boundaries of the fighter's torso. In particular, classifications are made as follows:

Left Cross: Punch begins from left MMA glove with positive X acceleration and positive Y acceleration.

Right Cross: Punch begins from right MMA glove with positive X acceleration and negative Y acceleration.

Left Hook; Punch begins from left MMA glove with positive X acceleration and negative Y acceleration. Punch terminates with negative Y acceleration.

Right Hook: Punch begins from right MMA glove with positive X acceleration and positive Y acceleration. Punch terminates with negative Y acceleration.

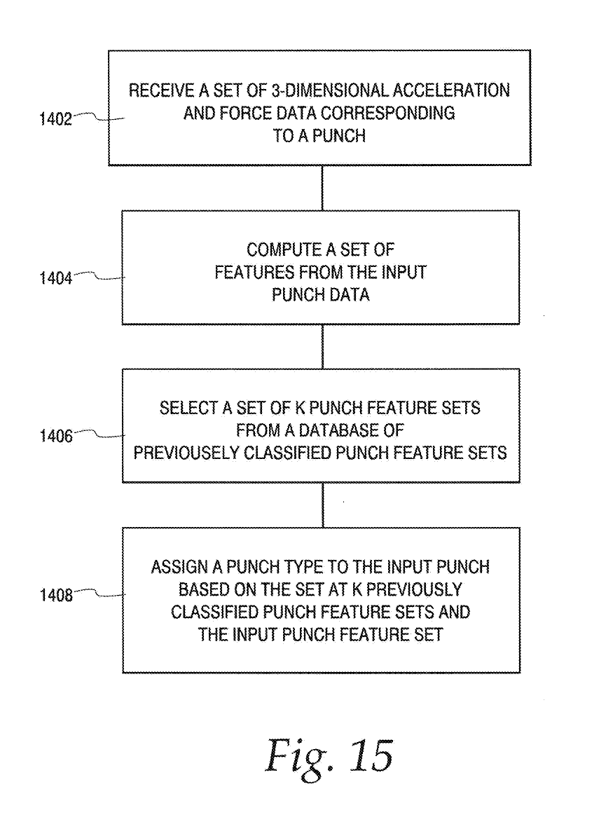

A second punch classification algorithm utilizes a simple machine learning approach to classify punches. In particular, a large database of punches are analyzed and classified using an algorithm such as that disclosed in FIG. 14. The classified punches are then used to help determine the punch types of input punches, using an algorithm such as that disclosed in FIG. 15.

Turning to FIG. 14, an automated punch classification algorithm is disclosed. This algorithm will typically be run on a remote server 128, or other powerful computer, such as that depicted in FIG. 2. In step 1302, a set of punch data is received comprising three-dimensional acceleration data as well as force data for the entire duration of the punch; i.e., from the first sample that forward movement is detected through the final sample that an impact is noted. This raw data is used to develop a set of features in step 1304. Each feature comprises a mathematical manipulation of one or more of the raw input datums; i.e., Fₙ₋₁, XAₙ₋₁, YAₙ₋₁, and ZAₙ₋₁. The set of features can be extremely large, such as one hundred or more, include, the raw samples themselves, sample-to-sample delta, and cross-differences of the acceleration quantities; i.e., XAₙ₋₁-YAₙ₋₁: XAₙ₋₁-ZAₙ₋₁; YAₙ₋₁-XAₙ₋₁; YAₙ₋₁-ZAₙ₋₁; ZAₙ₋₁-XAₙ₋₁, and ZAₙ₋₁-YAₙ₋₁. Many other punch data features can be derived and provide useful punch classification information.

In step 1306 a large number of previously classified sets of punches and punch data features are retrieved. These punches could have been classified by a separate algorithm, or they could have been manually classified by operators. Distance metrics for each generated feature are generated between the input punch feature data and each punch in the previously classified database in step 1308. A distance metric can comprise a simple difference operation or vector difference operation as appropriate, depending on the feature type. In step 1310, a punch type is determined for the input punch data based on the average of computed distance metrics of the input punch data with each of the previously classified punches. In particular, a set of X punches with the lowest average distance metric is assembled, and the punch type occurring most in the set of X is assigned to the input punch. This allows a large set of punches to be classified into a punch database, which can then be used by the algorithm disclosed in FIG. 15 to quickly classify an input punch.

Turning to FIG. 15, in step 1402, a set of three-dimensional acceleration and force data corresponding to a punch is received, and in step 1404, a limited set of selected features are computed and compiled as a Punch Vector P_{I}. Unlike the large feature set computed in step 1304, the set of features computed in step 1404 is selected to be only those that are most predictive of punch type. In step 1406, a set of K punches from a database of previously analyzed punches is selected by subtracting the punch vector P_{I} from the Punch Vector of each of the punches in the punch database P₁-P_{N}, and selecting only those with the smallest absolute value. A voting algorithm is then applied to the set of K punches to determine the classification of the input punch wherein the punch type that appears the most in the set of K punches is assigned to the input punch.

The algorithm of FIG. 15 is designed to be run on modest computing devices, such as modern day wireless smart phones and tablets. Such devices must be pre-loaded with a database of previously classified Punch Vectors, and accordingly, must include some amount of non-volatile memory, such as a rotating magnetic disk or FLASH memory. In addition, the computing device must include an input data port, such as a wireless data port.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below.

What is claimed is:

1. A mixed martial art glove including a striking surface and an upper wrist surface, the mixed martial art glove comprising:
i) an impact sensing device incorporated into an interior portion of the striking surface, the impact sensing device providing an impact signal;
ii) an impact processing circuit incorporated into an interior portion of the upper wrist surface, the impact processing circuit including:
1) a PC board;
2) a sewing hole formed into said PC board and adapted to allow the secure joining of the PC board to the interior portion of the wrist surface;
3) a microcontroller coupled to the impact sensing device; and
4) a wireless transceiver coupled to the microcontroller;
5) wherein the microcontroller acquires the impact signal and transmits a digital version of the impact signal using the wireless transceiver.

2. The mixed martial art glove of claim 1 wherein the impact processing circuit further comprises a signal conditional circuit coupled to the impact sensing device; the signal conditioning circuit conditioning the impact signal before the microcontroller acquires the impact signal.

3. The mixed martial art glove of claim 2 wherein the signal conditioning circuit includes a single supply rail-to-rail amplifier.

4. The mixed martial art glove of claim 2 wherein the signal conditioning circuit includes a low pass filter.

5. The mixed martial art glove of claim 4 wherein the low pass filter has at least one pole located at a frequency of 50 Herz or greater.

6. The mixed martial art glove of claim 1 wherein the wireless transceiver is adapted to communicate with a wireless mobile device.

7. The mixed martial art glove of claim 6 wherein the wireless mobile device is a smartphone or tablet.

8. A wireless computer adapted to interface with a pair of MMA gloves incorporating a wireless transceiver, the wireless computer further adapted to receive impact samples and three-axis acceleration sample sets from the pair of MMA gloves, the three-axis acceleration sample sets time correlated with the impact samples, the wireless computer executing a software program, the software program adapted to accumulate a plurality of impact samples and a plurality of three-axis acceleration sample sets, the software program adapted to segregate one or more punches from the plurality of impact data, and to classify the one or more punches into specific punch types using, the plurality of three-axis acceleration sample sets.

9. A server adapted to assemble a database of classified punch data, the server comprising:
i) an input device to receive punch data, including force data and three-axis acceleration data;
ii) a processor coupled to the input device, the processor adapted to generate a set of punch features from the punch data;
iii) the processor further adapted to retrieve a plurality of sets of previously classified punch features;
iv) the processor further adapted to compute a plurality of distance metrics from the set of punch features and the plurality of sets of previously classified punch features; and
v) determine a punch type from the plurality of distance metrics.

10. A wireless computer adapted to interface with a pair of MMA gloves incorporating a wireless transceiver, the wireless computer comprising:
i) a non-volatile memory device adapted to store a database of previously classified punch vectors;
ii) an input port adapted to receive force and three-dimensional acceleration samples;
iii) a processor coupled to the input port, the processor adapted to parse the force and three-dimensional acceleration samples to segregate a set of force and three-dimensional acceleration samples corresponding to a punch;
iv) the processor further adapted to compute a set of features from the set of force and three-dimensional acceleration data, the set of features comprising an input punch vector;
v) the processor further adapted to select a set of K punch vectors from the set of previously classified punch vectors; and
vi) the processor further adapted to assign a punch type to the punch based on the input punch vector and the set of K punch vectors.
